(19) United States
(12) Patent Application Publication
(10) Pub. No.: US 2026/0030534 A1
(43) Pub. Date: Jan. 29, 2026

(54) SYSTEM AND METHOD FOR MINIMIZING A STORAGE MODE DEPHASING ERROR AND IMPROVED AUXILIARY QUBIT RESET METHOD USING SAME

(71) Applicant: Nord Quantique Inc., Sherbrooke (CA)

(72) Inventors: Ross Shillito, Quebec City (CA); Lucas St-Jean, Sherbrooke (CA)

(21) Appl. No.: 18/784,087

(22) Filed: Jul. 25, 2024

(51) Int. Cl. G06N 10/40

(52) U.S. Cl. CPC G06N 10/40

(57) ABSTRACT

Described are various embodiments of a system and method for minimizing a storage mode dephasing error caused by a reset of the auxiliary qubit. In one embodiment, the method comprises the steps of performing on the auxiliary qubit a first η_{ge} pulse causing a |g [symbol] ↔|e [symbol] transition in said auxiliary qubit, waiting for a designated echo time duration; and performing on the auxiliary qubit a second η_{ge} pulse. The method may further comprise performing a f0g1 reset on the auxiliary qubit.

### FIELD OF THE DISCLOSURE

The present disclosure relates to quantum computing, and, in particular, to a system and method for minimizing a storage mode dephasing error and improved auxiliary qubit reset method using same.

### BACKGROUND

Bosonic codes provide a promising route for hardware-efficient quantum computing when compared with traditional approaches using few-level systems as qubits. The larger number of levels in bosonic systems provides room for redundancy within a single physical system, enabling one to perform quantum error correction at the single-qubit level, something impossible with a two-level system qubit. Furthermore, the dominant source of noise in most physical implementations of harmonic oscillators is photon loss, a type of error for which bosonic codes can be made tolerant to first order. Superconducting circuits is an important platform for bosonic codes due to the possibility of engineering desired interactions between an auxiliary nonlinear resource (like a transmon, for example) necessary to encode, read out and correct the bosonic codes in high-quality harmonic modes of a microwave cavity. Indeed, without the auxiliary nonlinear resource, only classical states can be created in harmonic oscillators using a coherent microwave source.

Resetting a transmon qubit to a predetermined state following a quantum computation (usually the ground state) is necessary for quantum computing in general, and particularly in quantum error correction. The easiest method to achieve such a reset in superconducting circuits is to use the natural relaxation of the circuit to its ground state. However, this method becomes unpractical when the relaxation time is much longer than the computation time, which is necessary to perform faithful quantum computation. In other words, the better the qubit is, the longer the relaxation-based reset takes, which is not reasonable tradeoff.

There is a known protocol and optimization method for a fast and autonomous reset for the specific case of a transmon coupled to a dissipative resonator (see for example “Fast and Unconditional All-Microwave Reset of a Superconducting Qubit”, Magnard et al., Phys. Rev. Lett. 121, 060502, 2018). The concept of this so-called f0g1 reset is to effectively transfer a potential excitation of the transmon qubit to an auxiliary resonator. If the lifetime of the resonator is much shorter than the relaxation time of the qubit, one gets back to the ground state of the system on a smaller timescale than simply through relaxation of the qubit alone.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a methods and systems that minimize dephasing errors caused in a storage mode caused by a f0g1 reset of a coupled auxiliary qubit.

In accordance with a first aspect, there is provided a method for pre-correcting a storage mode coupled to an auxiliary qubit comprising the steps of: performing on the auxiliary qubit a first η_{ge} pulse causing a |g [symbol] ↔|e [symbol] transition in said auxiliary qubit; waiting for a designated echo time duration; and performing on the auxiliary qubit a second η_{ge} pulse.

In some embodiments, the method further comprises the step of resetting the auxiliary qubit by: performing on the auxiliary qubit a ηef pulse causing a |e [symbol] ↔|f [symbol] transition on said auxiliary qubit; driving, via a second microwave drive, a |f0 [symbol] ↔|g1 [symbol] transition in said auxiliary qubit; and waiting a designated time duration for the auxiliary qubit to relax from a |g1 [symbol] state to a |g0 [symbol] state.

In some embodiments, the first and second η_{ge} pulses and the echo time duration are done in accordance with an effective Hamiltonian H_{echo,eff}=2χa^{†}a|g [symbol] g|.

In some embodiments, the echo time duration is selected so that the state |f [symbol] is substantially aligned with a state |g [symbol] .

In some embodiments, the auxiliary qubit is a transmon auxiliary qubit.

In some embodiments, the storage mode is provided by a secondary quantum subsystem comprising multiphoton states encoding a bosonic code.

In some embodiments, the bosonic code is selected from the group comprising: Gottesman-Kitaev-Preskill (GKP) code, a cat code or a binomial code.

In some embodiments, the secondary quantum subsystem comprises a superconducting microwave cavity.

In accordance with another aspect, there is provided a quantum computing device comprising: an auxiliary qubit; a storage mode provided by a secondary quantum subsystem coupled to the auxiliary qubit; a controller configured to operate a driving hardware comprising one or more microwave drives operably coupled to the auxiliary qubit and the secondary quantum subsystem, the controller comprising at least one processor coupled to a non-transitory computer-readable memory, the memory comprising instructions that when executed by the processor, cause the driving hardware to: perform on the auxiliary qubit a first η_{ge} pulse causing a |g [symbol] ↔|e [symbol] transition in said auxiliary qubit; wait for a designated echo time duration; and perform on the auxiliary qubit a second η_{ge} pulse.

In some embodiments, the instructions further cause the controller to reset the auxiliary qubit via the driving hardware by: performing on the auxiliary qubit a Href pulse causing a |e [symbol] ↔|f [symbol] transition on said auxiliary qubit; driving a |f0 [symbol] ↔|g1 [symbol] transition in said auxiliary qubit; and waiting a designated time duration for the auxiliary qubit to relax from a |g1 [symbol] state to a |g0 [symbol] state.

In some embodiments, the first and second η_{ge} pulses and echo time duration are done in accordance with an effective Hamiltonian H_{echo,eff}=2χa^{†}a|g [symbol] g|.

In some embodiments, the echo time duration is selected so that the state |f [symbol] is substantially aligned with a state |g [symbol] .

In some embodiments, the auxiliary qubit is a transmon auxiliary qubit.

In some embodiments, the storage mode provided by the secondary quantum subsystem comprises multiphoton states encoding a bosonic code.

In some embodiments, the bosonic code is selected from the group comprising: Gottesman-Kitaev-Preskill (GKP) code, a cat code or a binomial code.

In some embodiments, the secondary quantum subsystem comprises a superconducting microwave cavity.

In some embodiments, the device further comprises at least one resonator operably coupled to the auxiliary quit and to a measuring hardware.

In accordance with another aspect, there is provided a non-transitory computer-readable medium comprising instructions that, when executed by at least one processor of a controller operably coupled to a driving hardware comprising one or more microwave drives, the driving hardware operably coupled to an auxiliary qubit and a secondary quantum subsystem, causes the driving hardware to perform via the driving hardware on the auxiliary qubit a first η_{ge} pulse causing a |g [symbol] ↔|e [symbol] transition in said auxiliary qubit; wait for a designated echo time duration; and perform via the driving hardware on the auxiliary qubit a second η_{ge} pulse.

In some embodiments, the instructions further cause the driving hardware to reset the auxiliary qubit by: performing on the auxiliary qubit a η_{ef} pulse causing a |e [symbol] ↔|f [symbol] transition on said auxiliary qubit; driving a |f0 [symbol] ↔|g1 [symbol] transition in said auxiliary qubit; and waiting a designated time duration for the auxiliary qubit to relax from a |g1 [symbol] state to a |g0 [symbol] state.

Other aspects, features and/or advantages will become more apparent upon reading of the following non-restrictive description of specific embodiments there0f, given by way of example only with reference to the accompanying drawings.

### BRIEF DESCRIPTION OF THE DRAWINGS

Several embodiments of the present disclosure will be provided, by way of examples only, with reference to the appended drawings, wherein:

FIG. 1 is a schematic diagram illustrating an exemplary cQED quantum computing device, in accordance with one embodiment;

FIG. 2 is a plot illustrating the execution of the small-big-small (sBs) protocol, in accordance with one embodiment;

FIG. 3A and FIG. 3B are schematic diagram illustrating the principes behind the f0g1 reset, in accordance with one embodiment;

FIG. 4 is a schematic diagram illustrating the dephasing error caused by the f0g1 reset, in accordance with one embodiment;

FIG. 5 is a schematic diagram illustrating the improve Reset Echo procedure, in accordance with one embodiment; and

FIG. 6 is a plot illustrating the performance improvements resulting from the Reset Echo procedure, in accordance with one embodiment.

Elements in the several drawings are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

When introducing elements of aspects of the disclosure or the examples there0f, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

The systems and methods described herein provide, in accordance with different embodiments, a substantial reduction or minimization of a rotational dephasing error on a storage mode coupled to an auxiliary qubit that normally results when performing a f0g1 reset on the auxiliary qubit. This “Reset Echo” protocol allows to minimize or reduce the dephasing error and provides notable improvements in performance.

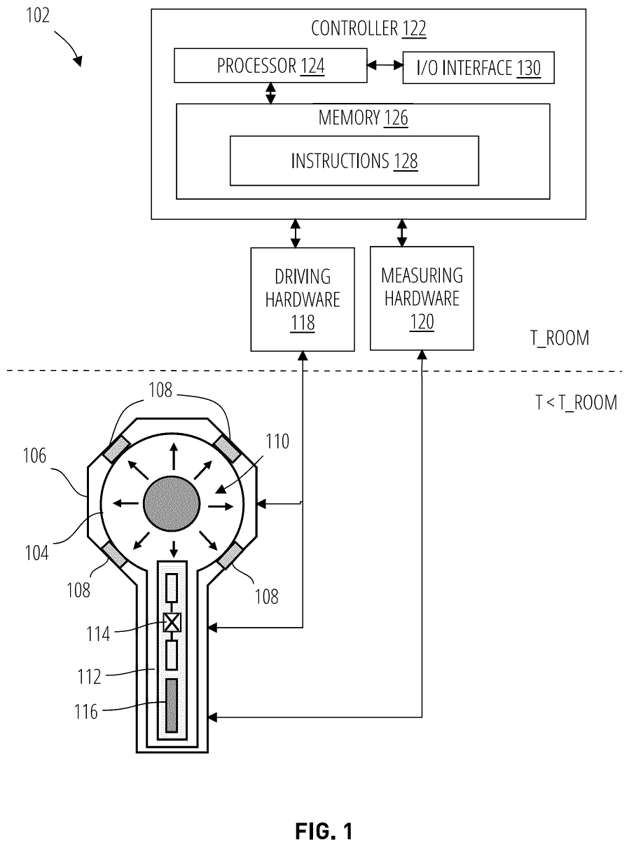

The described method may be implemented in different quantum computing architectures or systems, as will readily be understood by the person skilled in the art. As a non-limiting example, FIG. 1 illustrates schematically a top view of a cQED device 102 that can be used with the improved reset method, in accordance with one embodiment. The illustrated cQED device 102 comprises a 3D superconducting microwave cavity 104, for example a three-dimensional seamless coaxial-type superconducting microwave cavity configured to house and sustain therein long-lived microwave modes 110 using a rotation-symmetric electric field. The three-dimensional superconducting microwave cavity 104 is configured to host and maintain therein a plurality of long-lived bosonic codes or qubits, such as Gottesman-Kitaev-Preskill (GKP) qubits. However, other bosonic codes or qubits known in the art may also be used or implemented by the cavity, for example cat qubits or binomial qubits or others. In addition, the illustrated cavity comprises only one post in the middle, however multipost cavities may be used as well.

In this exemplary embodiment, the three-dimensional superconducting microwave cavity 104 comprises an external casing 106 comprising eight external vertical side walls, with some comprising coupling ports 108 allowing to build multi-unit architectures in an extensible square array configuration. In some embodiments, the auxiliary resources 112 comprises the auxiliary transmon 114, on which the reset is performed, and linear readout resonator 116. The readout resonator 116 is dispersively coupled to the transmon 114 and may be used, at least in part, to control and read the transmon state. Different types of resonators known in the art may be considered, including for example one or more Purcell filtered resonators. The skilled person in the art will appreciate that different techniques or implementations of an auxiliary resource is known in the art that the illustrated device is used as an example only.

The driving hardware 118 typically comprises one or more microwave generators and an arbitrary waveform generator (AWG) or other configured to generate coherent microwave drives and pulses. These may be used for example to prepare or initialize the transmon in a given state using control pulses. The one or more generators are typically coupled via one or more transmission lines to the cavity 104 using for example a cavity control port (not shown) and to the auxiliary resources 112—and thus the transmon 114 and the resonator 116—using for example an auxiliary control port (not shown).

The measuring hardware 120 is used to read out the state of the auxiliary transmon 114. Thus, the measuring hardware 120 typically comprises one or more digitizers configured to detect and measure microwave signals or tones scattered off the read-out resonator 116 via a readout port (not shown). The skilled person in the art will understand that different hardware variations and/or techniques may be used to perform the qubit readout, without limitations. It will also be understood that conventional or typical hardware components, such as amplifiers, band-pass filters, up or down converters, analog-to-digital converters (ADC), or others, may also be included in the driving hardware 118 and the measuring hardware 120, without limitations.

Both the driving hardware 118 and the measuring hardware 120 are coupled to a controller 122. The controller 122 is typically provided in the form of a classical computer, which comprises one or more classical processors 124 coupled to a memory 226 and a input/output interface 228. The controller 122 is used to operate the driving hardware 118 and the measuring hardware 120 in accordance with a set of instructions 128 so as to set, control and measure quantum states in the device 102 to implement therewith bosonic codes or qubits, and control logical operations therewith. In addition, cooling hardware is typically used to maintain the superconducting components, namely the superconducting cavity 104 and the transmon 114, at near-zero Kelvin temperatures. Different means of cooling these components at near-zero Kelvin temperatures well known in the art may be used, without limitations, and are not illustrated. In contrast, the driving hardware 118, measuring hardware 120 and controller 122, or at least parts there0f, are typically operated at various higher temperatures.

The hardware discussed above is given as an example only. Other architectures may be used to implement the discussed method, including for example, and without limitation, using other types of oscillators hosting the bosonic states, including 2D superconducting cavities, and other types of auxiliary qubits, such as fluxonium qubits.

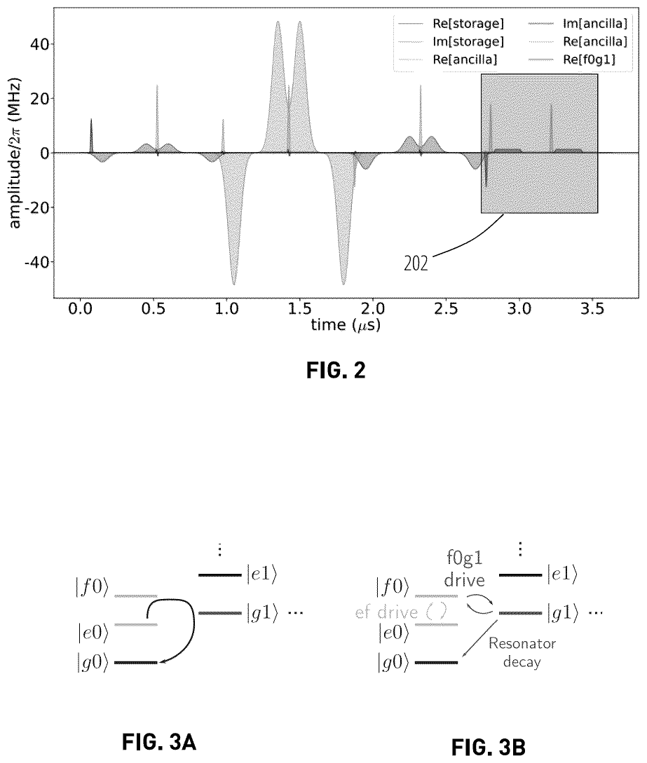

Going back to the f0g1 reset procedure itself, such reset procedures may be used in various dissipative stabilization protocols tailored to obtain highly squeezed GKP states. One such protocol is known as the autonomous small-BIG-small (sBs) protocol. An example of this protocol is illustrated in the schematic plot of FIG. 2, which involves at the end there0f two reset procedures (the sequence of pulses shown in the rectangle). The key ingredient of the original f0g1 reset is to activate an effective exchange of energy between the second excited state of the transmon (state f) in the absence of photons in the resonator (state 0, combined state being f0) and the ground state of the transmon (state g) with a single photon in the resonator (state 1, combined state being g1), hence the f0g1 name. This effective interaction, turned on through a microwave drive on the system at the appropriate frequency, sends an excitation in the second excited state of the transmon (state f) back to the ground state (state g). To also reset the transmon in the presence of a population in the first excited state (state c), an additional drive is used to drive oscillations between the e and f transmon states (called ef drive hereafter). Combined with the resonator relaxation from the g1 state to the g0 state, the protocol takes any excitation in either e0 or f0 states to the g0 state, as desired. The known f0g1 reset protocol fixes both the ef and f0g1 drives to be applied simultaneously and their frequencies to be resonant with the e0f0 and f0g1 transitions, respectively.

FIG. 3A and FIG. 3B show schematic energy level diagrams illustrating the principle behind the f0g1 reset protocol. FIG. 3A shows how the f0g1 reset protocol enables one to transfer an excitation in the first or second excited state of the transmon to its ground state on a timescale limited only by the relaxation rate of a coupled auxiliary resonator. FIG. 3B shows how the f0g1 reset is made possible through an effective exchange interaction between f0 and g1 states is enabled by a microwave drive resonant with the f0g1 transition. Combined with the relaxation of the resonator from g1 to g0 and a microwave drive resonant with the e0f0 transition, any population in either e0 or f0 states is transferred to the g0 state, as desired.

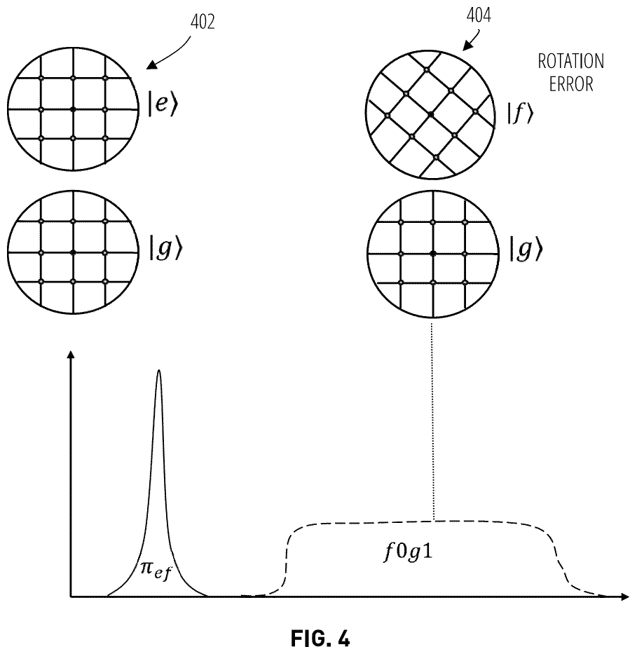

However, the f0g1 reset protocol does have a problem, namely that it can cause a dephasing error on the oscillator hosted state (e.g., the exemplary GKP state illustrated herein but also other bosonic states in other implementations) in the storage mode. This is illustrated schematically in FIG. 4 which shows how the different GKP states (illustrated in a phase representation) are affected by the different pulses. It is shown that the GKP state 408, not being in the ground state initially, is rotated into the state 402 during the f0g1 pulse. Thus, the GKP state is initially aligned with the |e [symbol] state and the |g [symbol] state, but by the time the reset process terminates, the GKP state corresponding to the |f [symbol] state has rotated, and thus when the qubit is reset to |g [symbol] , this causes the dephasing error.

This is because the Hamiltonian describing the process is:

$${H}_{echo , eff} = 2 χ {a}^{†} a \vert e 〉 〈 e \vert + 4 ( χ + {χ}^{′} ) {a}^{†} a \vert f 〉 〈 f \vert \qquad ( Eq . l )$$

where χ and χ ′ are first-order and second-order cross-Kerr terms between the transmon qubit and the storage mode, where |e [symbol] , |f [symbol] correspond to the first and second excited states of the transmon qubit, respectively and at, a are the creation and annihilation operators of the storage bosonic mode.

Therefore, because the qubit is in the |e [symbol] state initially, the GKP state 408 is rotated by “2χ”, while if the qubit is in the |f [symbol] state, the GKP state 510 is rotated by 4 (χ+χ′). This additional rotation creates the dephasing error. Therefore, there is a need for an improved reset protocol that prevents or at least greatly reduces the dephasing error from occurring.

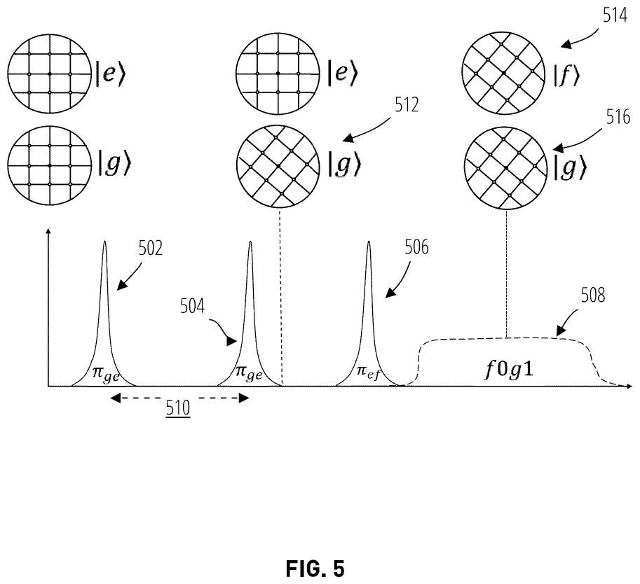

With reference to FIG. 5, and in accordance with one embodiment, an improved reset protocol, herein referred to as the “Reset Echo” protocol will be described. FIG. 5 illustrates the process in a similar fashion to FIG. 4, and shows the sequence of pulses. In this embodiment, the protocol includes first performing a sequence of two η_{ge} pulses 502 and 504, separated by a “reset echo time” duration 510. This deliberately “over rotates” the |g) state at 512. This following sequence of pulses can be described via the following effective Hamiltonian term:

$${H}_{echo , eff} = 2 χ {a}^{†} a \vert g 〉 〈 g \vert \qquad ( eq . 2 )$$

wherein |g [symbol] , |f [symbol] corresponds to ground state of the transmon qubit. In this embodiment, the reset echo time is approximately

$${T}_{echo} = \frac{χ + {χ}^{′}}{χ} {T}_{f 0 g 1} ,$$

such that the |f [symbol] state is approximately aligned with the |g> state in the center of the f0g1 pulse. Here T_f0g1 is the total duration of the f0g1 pulse. Exemplary values include χ/2η≈10 kHz and χ′/2η≈5 kHz, however both these values may range, in some embodiments, from 1 kHz-50 kHz. In addition, it will be appreciated that other constraints, such as the storage decay and/or the duration of the qubit n pulses, might mean the optimal T_{echo}time is not this value. Typical values for the echo time range from 50 ns-500 ns, depending on the other parameters. The optimal T_{echo} is generally best found through well-known optimization and or calibration procedures.

Once the pre-correction has been applied, the f0g1 reset may be performed by subsequently using the η_{ef} and f0g1 reset pulses, which allows the |f [symbol] state (at 514) to “catch up” and realign with the |g [symbol] state (at 516), greatly minimizing the dephasing between them.

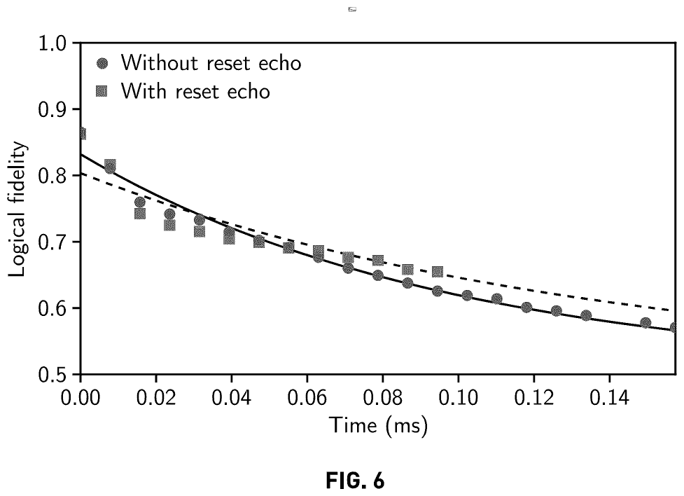

While it should be noted that this only corrects the average rotation, since the f0g1 procedure is not instantaneous which means that there is still a small dephasing present, it does provide a large improvement. FIG. 6 shows exemplary experimental results where both the known classical f0g1 reset procedure and the Reset Echo procedure were applied using a same system configuration. The results show a 40% gain with a 5 us inter round delay when using the Echo Reset (T_{L}=0.136 (21) ms with the Echo Reset vs T_{L}=0.097 (7) ms without).

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Information as herein shown and described in detail is fully capable of attaining the above-described object of the present disclosure, the presently preferred embodiment of the present disclosure, and is, thus, representative of the subject matter which is broadly contemplated by the present disclosure.

What is claimed is:

1. A method for pre-correcting a storage mode coupled to an auxiliary qubit comprising the steps of:
performing on the auxiliary qubit a first η_{ge} pulse causing a |g [symbol] χ|e [symbol] transition in said auxiliary qubit;
waiting for a designated echo time duration; and
performing on the auxiliary qubit a second η_{ge} pulse.

2. The method of claim 1, further comprising the step of resetting the auxiliary qubit by:
performing on the auxiliary qubit a η_{ef} pulse causing a |e [symbol] ↔|f [symbol] transition on said auxiliary qubit;
driving a |f0 [symbol] ↔|g1 [symbol] transition in said auxiliary qubit; and
waiting a designated time duration for the auxiliary qubit to relax from a |g1 [symbol] state to a |g0 [symbol] state.

3. The method of claim 1, wherein the first and second η_{ge} pulses and the echo time duration are done in accordance with an effective Hamiltonian H_{echo,eff}=2χa^{†}a|g [symbol] g|.

4. The method of claim 3, wherein the echo time duration is selected so that the state |f [symbol] is substantially aligned with a state |g [symbol] .

5. The method of claim 1, wherein the auxiliary qubit is a transmon auxiliary qubit.

6. The method of claim 1, wherein the storage mode is provided by a secondary quantum subsystem comprising multiphoton states encoding a bosonic code.

7. The method of claim 6, wherein the bosonic code is selected from the group comprising: Gottesman-Kitaev-Preskill (GKP) code, a cat code or a binomial code.

8. The method of claim 6, wherein the secondary quantum subsystem comprises a superconducting microwave cavity.

9. A quantum computing device comprising:
an auxiliary qubit;
a storage mode provided by a secondary quantum subsystem coupled to the auxiliary qubit;
a controller configured to operate a driving hardware comprising one or more microwave drives operably coupled to the auxiliary qubit and the secondary quantum subsystem, the controller comprising at least one processor coupled to a non-transitory computer-readable memory, the memory comprising instructions that when executed by the processor, cause the driving hardware to:
perform on the auxiliary qubit a first η_{ge} pulse causing a |g [symbol] ↔|e [symbol] transition in said auxiliary qubit;
wait for a designated echo time duration; and
perform on the auxiliary qubit a second η_{ge} pulse.

10. The quantum computing device of claim 9, the instructions further cause the controller to reset the auxiliary qubit via the driving hardware by:
performing on the auxiliary qubit a Href pulse causing a |e [symbol] ↔|f [symbol] transition on said auxiliary qubit;
driving a |f0 [symbol] ↔|g1 [symbol] transition in said auxiliary qubit; and
waiting a designated time duration for the auxiliary qubit to relax from a |g1 [symbol] state to a |g0 [symbol] state.

11. The quantum computing device of claim 9, wherein the first and second η_{ge} pulses and echo time duration are done in accordance with an effective Hamiltonian H_{echo,eff}=2χa^{†}a|g [symbol] g|.

12. The quantum computing device of claim 9, wherein the echo time duration is selected so that the state |f [symbol] is substantially aligned with a state |g [symbol] .

13. The quantum computing device of claim 9, wherein the auxiliary qubit is a transmon auxiliary qubit.

14. The quantum computing device of claim 9, wherein the storage mode provided by the secondary quantum subsystem comprises multiphoton states encoding a bosonic code.

15. The quantum computing device of claim 14, wherein the bosonic code is selected from the group comprising: Gottesman-Kitaev-Preskill (GKP) code, a cat code or a binomial code.

16. The quantum computing device of claim 14, wherein the secondary quantum subsystem comprises a superconducting microwave cavity.

17. The quantum computing device of claim 9, further comprising at least one resonator operably coupled to the auxiliary quit and to a measuring hardware.

18. A non-transitory computer-readable medium comprising instructions that, when executed by at least one processor of a controller operably coupled to a driving hardware comprising one or more microwave drives, the driving hardware operably coupled to an auxiliary qubit and a secondary quantum subsystem, causes the driving hardware to:
perform via the driving hardware on the auxiliary qubit a first η_{ge} pulse causing a |g [symbol] ↔|e [symbol] transition in said auxiliary qubit;
wait for a designated echo time duration; and
perform via the driving hardware on the auxiliary qubit a second Ige pulse.

19. The non-transitory computer-readable medium of claim 18, wherein the instructions further cause the driving hardware to reset the auxiliary qubit by:
performing on the auxiliary qubit a n_{ef} pulse causing a |e [symbol] ↔|f [symbol] transition on said auxiliary qubit;
driving a |f0 [symbol] ↔g1 [symbol] transition in said auxiliary qubit; and
waiting a designated time duration for the auxiliary qubit to relax from a |g1 [symbol] state to a |g0 [symbol] state.
